(19) United States
(12) Patent Application Publication
(10) Pub. No.: US 2007/0216305 A1
(43) Pub. Date: Sep. 20, 2007

(54) Plasma display panel

(76) Inventor: Jae-Young Yeo, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/714,437

(22) Filed: Mar. 5, 2007

(30) Foreign Application Priority Data
Mar. 14, 2006 (KR) 10-2006-0023517

(51) Int. Cl. H01J 17/49

(52) U.S. Cl. 313/582

(57) ABSTRACT

Provided is a plasma display panel that has a reduced noise radiated from around address electrodes by having ground electrodes formed between the address electrodes when using a single scan method. The plasma display panel includes: a first substrate and a second substrate facing each other; a plurality of barrier ribs dividing a space between the first and second substrates into a plurality of discharge cells; a plurality of pairs of sustain electrodes arranged on the first substrate so as to face the second substrate and so that the sustain electrodes in each pair are spaced apart from one another, each pair of the sustain electrodes including a common electrode and a scan electrode; a first dielectric layer covering the pairs of sustain electrodes; phosphor layers disposed on inner walls of the discharge cells; a plurality of address electrodes intersecting the pairs of sustain electrodes in the discharge cells and extending across the second substrate; a plurality of ground electrodes formed between the address electrodes to be spaced apart from the address electrodes; and a discharge gas filled in the discharge cells.

### CROSS-REFERENCE TO RELATED PATENT APPLICATIONS

This application claims the benefit of Korean Patent Application No. 10-2006-0023517, filed on Mar. 14, 2006, in the Korean Intellectual Property Office, the disclosure of which is incorporated herein in its entirety by reference.

### BACKGROUND OF THE INVENTION

1. Field of the Invention

The present embodiments relate to a plasma display panel (PDP), and more particularly, to a PDP that has a reduced radiation noise generated from around long address electrodes thereof.

2. Description of the Related Art

In general, plasma display panels (PDPs) display a desired image including text or graphics by injecting a discharge gas into a sealed space between two substrates on which electrodes are formed and exciting phosphor layers with ultraviolet (UV) rays generated by the gas discharge.

PDPs can be categorized into a direct current (DC) type and an alternating current (AC) type according to the types of driving voltages applied to discharge cells, for example, according to a discharge mechanism. PDPs can also be categorized into a facing discharge type and a surface discharge type according to the arrangement of electrodes.

In DC PDPs, all electrodes are exposed to a discharge space and electric charges move directly between facing electrodes. In AC PDPs, at least one electrode is covered by a dielectric layer so that instead of directly moving electric charges between facing electrodes, ions and electrons generated due to a discharge produce a wall voltage by sticking to a surface of the dielectric layer, and the discharge is sustained by a sustaining voltage.

In facing discharge PDPs, an address electrode faces a scan electrode in each discharge cell, and address and sustain discharges occur between the two electrodes. In surface discharge PDPs, an address electrode and a sustain electrode including a common electrode and a scan electrode are arranged in each discharge cell to cause address and sustain discharges.

FIG. 1 is a cross-sectional view of a conventional PDP 100.

Referring to FIG. 1, the conventional PDP 1000 includes a first substrate 1110, a second substrate 1120 facing the first substrate 1110, scan electrodes 1112 and bus electrodes 1113 formed on a bottom surface of the first substrate 1110, a first dielectric layer 1114 covering the scan electrodes 1112 and the bus electrodes 1113, a protective layer 1115 coated on a surface of the first dielectric layer 1114, address electrodes 1121 formed on a top surface of the second substrate 1120, a second dielectric layer 1123 covering the address electrodes 1121, barrier ribs 1130 installed between the first substrate 1110 and the second substrate 1120, and red, green, and blue phosphor layers 1140 coated on inner walls of discharge spaces partitioned by the barrier ribs 1130.

Since a single scan method is more cost effective than a dual scan method which has previously been widely used, the single scan method has recently become popular. However, the single scan method has a drawback in that radiation noise increases sharply during a scan period since the address electrodes 1121 are long.

Although a chassis disposed behind the second substrate 1120 provides a ground for the PDP 1000, the chassis is too far from the address electrodes 1121 and thus it fails to act as a path through which current returns. When the second substrate 1120 having a thickness of about 3 mm is used and a non-conductive adhesive sheet is used to bond the PDP 1000 to the chassis, the distance between the address electrodes 1121 and the chassis that provides the ground is more than about 5 mm.

After the scan electrodes 1112 and the address electrodes 1121 perform a discharge to accumulate wall charges on cells selected during the scan period, there are no paths through which current can return, around the address electrodes 1121. Consequently, a dipole antenna is formed and noise is radiated from the address electrodes 1121. The PDP of the current embodiments is capable of reducing noise radiated around the address electrodes.

### SUMMARY OF THE INVENTION

The present embodiments provide a plasma display panel that has a reduced noise radiated from around address electrodes by having ground electrodes formed between the address electrodes when using a single scan method.

According to an aspect of the present embodiments, there is provided a plasma display panel comprising: a first substrate and a second substrate facing each other; a plurality of barrier ribs dividing a space between the first and second substrates into a plurality of discharge cells; a plurality of pairs of sustain electrodes arranged on the first substrate so as to face the second substrate and so that the sustain electrodes in each pair are spaced apart from one another, each pair of the sustain electrodes including a common electrode and a scan electrode; a first dielectric layer covering the pairs of sustain electrodes; phosphor layers disposed on inner walls of the discharge cells; a plurality of address electrodes intersecting the pairs of sustain electrodes in the discharge cells and extending across the second substrate; a plurality of ground electrodes formed between the address electrodes to be spaced apart from the address electrodes; and a discharge gas filled in the discharge cells.

The address electrodes and the ground electrodes may be parallel to each other.

The plasma display panel may further comprise a second dielectric layer covering the address electrodes and the ground electrodes.

### BRIEF DESCRIPTION OF THE DRAWINGS

The above and other features and advantages of the present embodiments will become more apparent by describing in detail exemplary embodiments thereof with reference to the attached drawings in which:

FIG. 1 is a cross-sectional view of a conventional plasma display panel (PDP);

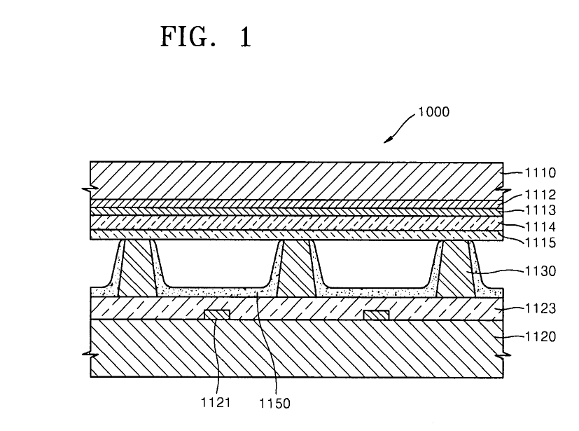

FIG. 2 is an exploded perspective view of a PDP according to an embodiment;

FIG. 3 is a cross-sectional view taken along line III-III of FIG. 2; and

FIG. 4 is a schematic view illustrating the arrangement of address electrodes 121 and ground electrodes 122 of the PDP of FIGS. 2 and 3.

### DETAILED DESCRIPTION OF THE INVENTION

The present embodiments will now be described more fully with reference to the accompanying drawings, in which exemplary embodiments are shown.

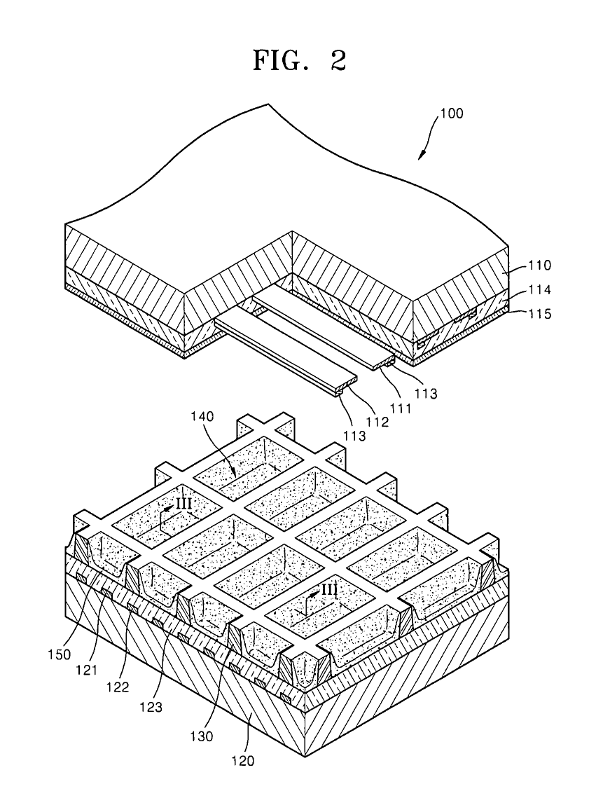

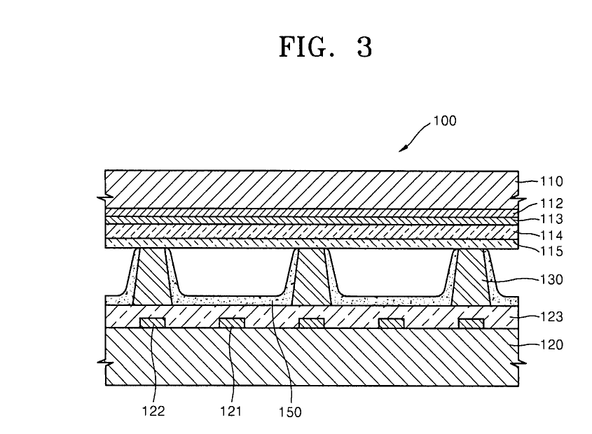

FIG. 2 is an exploded perspective view of a plasma display panel (PDP) 100 according to an embodiment. FIG. 3 is a cross-sectional view taken along line III-III of FIG. 2.

Referring to FIGS. 2 and 3, the PDP 100 includes a first substrate 110, and a second substrate 120 spaced a predetermined distance from the first substrate 110 to be parallel to the first substrate 110.

The first substrate 110 is a transparent substrate formed of a material through which visible light generated by a discharge can be transmitted, for example, glass. However, the present embodiments are not limited thereto. The first substrate 110 may be opaque and the second substrate 120 may be transparent, or both the first substrate 110 and the second substrate 120 may be transparent. Alternatively, each of the first substrate 110 and the second substrate 120 may be formed of a semitransparent material, and a color filter (not shown) may be installed thereon or therein.

A plurality of pairs of sustain electrodes, each pair including a common electrode 111 and a scan electrode 112, are arranged on a bottom surface of the first substrate 110 and are formed of transparent conductive materials, such as, for example, indium tin Oxide (ITO).

Bus electrodes 113 having smaller widths than those of the common electrodes 111 and the scan electrodes 112 are installed on bottom surfaces of the common electrodes 111 and the scan electrodes 112, and are formed of a metallic material to reduce line resistance of the common electrodes 111 and the scan electrodes 112.

A first dielectric layer 114 covers the common electrodes 111, the scan electrodes 112, and the bus electrodes 113.

The first dielectric layer 114 prevents direct conduction between the common electrodes 111 and the scan electrodes 112 during a sustain discharge, prevents damage to the common and scan electrodes 111 and 112 due to direct collision of charged particles on the common and scan electrodes 111 and 112, and accumulates wall charges by inducing charged particles. The first dielectric layer 114 may be formed of, for example, PbO, B₂O₃, or SiO₂.

A protective layer 115 is formed on a bottom surface of the first dielectric layer 114. The protective layer 115 can be formed of for example, magnesium oxide (MgO). The protective layer 115 prevents the common electrodes 111 and the scan electrodes 112 from being damaged by sputtering of plasma particles, and reduces a discharge voltage by emitting a secondary emission of electrons.

Address electrodes 121 are formed on a top surface of the second substrate 120. The address electrodes 121 cooperate with the scan electrodes 112 to perform an address discharge.

Ground electrodes 122 are formed between the address electrodes 121 to reduce noise. The ground electrodes 122 are formed between the address electrodes 121 to be spaced by a predetermined distance from the address electrodes 121, and the address electrodes 121 and the ground electrodes 122 are parallel to each other.

Referring to FIG. 3, impedance between the address electrodes 121 and the scan electrodes 112 is reduced by inserting the ground electrodes 122 between the address electrodes 121. Accordingly, current flowing through the address electrodes 121 returns to the ground electrodes 122 that are disposed below barrier ribs 130, thereby reducing electromagnetic interference (EMI) noise generated in a single scan method.

Impedance Z between the address electrodes 121 and the ground electrodes 122 is calculated by

$$Z = \frac{1}{2 π fc} \qquad ( 1 )$$

where f denotes the frequency of current flowing through the address electrodes 121 in the single scan method, and c denotes capacitance between the address electrodes 121 and the ground electrodes 122.

As the distance between the address electrodes 121 and the ground electrodes 122 decreases, the capacitance c increases and thus the impedance z decreases. Accordingly, after the scan electrodes 112 and the address electrodes 121 perform a discharge to accumulate wall charges on cells selected during a scan period, paths through which current returns to the ground electrodes 122 are formed around the address electrodes 121, thereby reducing EMI noise in the address electrodes 121.

Radiation energy created by the return paths between the address electrodes 121 and the ground electrodes 122 is calculated by

$${E}_{DM} = ( {I}_{DM} s A ) ( \frac{{f}^{2}}{r} ) \qquad ( 2 )$$

where E denotes radiation energy, A denotes the area of the return paths between the address electrodes 121 and the ground electrodes 122, f denotes the frequency of current flowing through the address electrodes 121 in the single scan method, and r denotes the distance between the address electrodes 121 and the ground electrodes 122.

Referring to Equation 2, since the radiation energy E is proportional to the area A of the return paths between the address electrodes 121 and the ground electrodes 122, the radiation energy E can be reduced by reducing the area A of the return paths. Without such return paths, energy generated by the address electrodes 121 is radiated to space. However, if the ground electrodes 122 are spaced by a predetermined distance from the address electrodes 121 as shown in FIGS. 2 and 3, the area A of the return paths is minimized and energy is radiated through the ground electrodes 122 to be reduced, thereby reducing the EMI of the PDP 100.

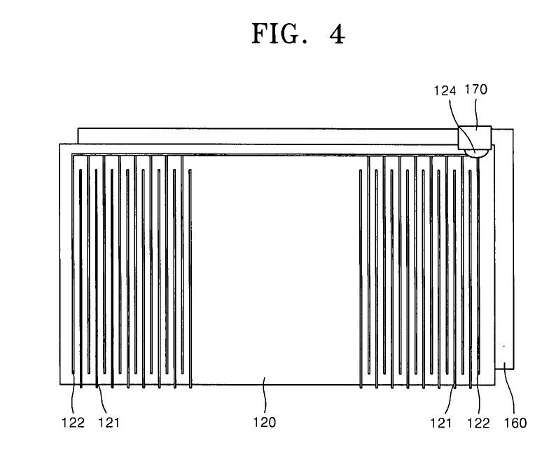

FIG. 4 is a schematic view illustrating the arrangement of the address electrodes 121 and the ground electrodes 122 of FIGS. 2 and 3.

The address electrodes 121 are connected to a tape carrier package (TCP, not shown) disposed under the second substrate 120. In order to connect a chassis 160 to the ground electrodes 122 for EMI reduction, a ground electrode terminal 124 is disposed on a side portion of the upper surface of the second substrate 120 and allows all the ground electrodes 122 to be commonly connected thereto.

The ground electrode terminal 124 and the chassis 160 are shorted using a tape 170 or a clip (not shown) formed of an electrically conductive material such as, for example, aluminum. As a result, the ground electrodes 122 are connected to the chassis 160. Accordingly, EMI noise generated when the address electrodes 121 perform a discharge can be reduced by means of the ground electrodes 122.

Referring back to FIGS. 2 and 3, a second dielectric layer 123 covers the address electrodes 121 and the ground electrodes 122. The second dielectric layer 123 also protects the address electrodes 121 and the ground electrodes 122, similarly to the first dielectric layer 114.

The barrier ribs 130 are formed on a top surface of the second dielectric layer 123. The barrier ribs 130 maintain a discharge distance between the discharge cells, and prevent electrical and optical cross-talk between the discharge cells.

Barrier ribs 130 together with a common electrode 111, a scan electrode 112, and an address electrode 121 form one discharge space, which is called a unit discharge cell. The unit discharge cell forms a pixel.

The discharge cells 140 each having an identical shape are formed in columns in the direction where the common electrodes 111 and the scan electrodes 112 extend. Red, green, and blue color phosphor materials are coated on the top surface of the second dielectric layer 123 that constitutes bottom surfaces of the discharge cells 140, and on both side surfaces of the barrier ribs 130 to form phosphor layers 150.

The phosphor layers 150 receive ultraviolet (UV) rays and generate visible light. The red phosphor layers formed in the discharge cells that emit red light contain a phosphor material such as Y(V,P)O₄:Eu, the green phosphor layers formed in the discharge cells that emit green light contain a phosphor material such as Zn₂SiO₄:Mn, and the blue phosphor layers formed in the discharge cells that emit blue light contain a phosphor material such as BAM:Eu.

When the first substrate 110 and the second substrate 120 are coupled to each other, air is filled in an inner space of the PDP 100. After the air filled in the PDP 100 is completely exhausted, the PDP 100 is filled with an appropriate discharge gas that can increase discharge efficiency. The discharge gas may be a gas mixture such as, for example, Ne—Xe, He—Xe, or He—Ne—Xe gas.

A discharge process of the PDP 100 constructed as above will now be explained.

First, when a predetermined address voltage is applied between the address electrodes 121 and the common electrodes 111 from an external power source, an address discharge occurs, and discharge cells in which a sustain discharge is to occur are selected. Next, when a discharge sustain voltage is applied between the common electrodes 111 and the scan electrodes 112 of the selected discharge cells, wall charges accumulated on the common electrodes 111 and the scan electrodes 112 begin to move to generate a sustain discharge. The sustain discharge excites the discharge gas to high energy levels and the discharge gas emits UV rays when transitions from high to low energy levels occur in the discharge gas. The UV rays excite the phosphor materials of the phosphor layers 140 coated on the inner walls of the discharge cells to high energy levels. The phosphor materials emit visible light when transitions from high to low energy levels occur in the phosphor materials. When the emitted visible light is transmitted through the first substrate 110, an image that a user can recognize is formed.

As described above, since the ground electrodes are formed between the address electrodes when using the single scan method, impedance between the address electrodes and the ground electrodes is reduced, and paths through which current returns from the address electrodes to the ground electrodes are formed to reduce noise.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A plasma display panel comprising:
a first substrate and a second substrate facing each other;
a plurality of barrier ribs dividing a space between the first and second substrates into a plurality of discharge cells;
a plurality of pairs of sustain electrodes arranged on the first substrate so as to face the second substrate, wherein the sustain electrodes in each pair are spaced apart from one another, and wherein each pair of the sustain electrodes includes a common electrode and a scan electrode;
a first dielectric layer covering the pairs of sustain electrodes;
phosphor layers disposed on inner walls of the discharge cells;
a plurality of address electrodes intersecting the pairs of sustain electrodes in the discharge cells and extending across the second substrate;
a plurality of ground electrodes formed between the address electrodes spaced apart from the address electrodes; and
a discharge gas filled in the discharge cells.

2. The plasma display panel of claim 1, wherein the address electrodes and the ground electrodes are parallel to each other.

3. The plasma display panel of claim 1, further comprising a second dielectric layer covering the address electrodes and the ground electrodes.

4. The plasma display panel of claim 1, further comprising a ground electrode terminal allowing the plurality of ground electrodes to be commonly connected thereto,
wherein the ground electrode terminal is connected to a chassis, which supports the plasma display panel by conductive connecting means.

5. The plasma display panel of claim 1, wherein the discharge gas comprises at least one of Ne—Xe gas, He—Xe gas and He—Ne—Xe gas.

6. The plasma display panel of claim 1, wherein the first dielectric layer comprises at least one of PbO, B₂O₃, and SiO₂

7. The plasma display panel of claim 3, wherein the second dielectric layer comprises at least one of PbO, B₂O₃, and SiO₂

8. The plasma display panel of claim 1, wherein the protective layer comprises magnesium oxide (MgO).

9. The plasma display panel of claim 1, wherein the phosphor layers comprise at least one of Y(V,P)O₄:Eu, Zn₂SiO₄:Mn and BAM:Eu.

10. The plasma display panel of claim 1, further comprising a tape or clip contacting both the ground electrode terminal and the chassis.
